(19) United States
(12) Patent Application Publication
(10) Pub. No.: US 2002/0161997 A1
(43) Pub. Date: Oct. 31, 2002

(54) Content distribution system

(75) Inventors: Shigeichiro Yamasaki, Kawasaki-shi (JP); Masatoshi Shiouchi, Kawasaki-shi (JP); Tadashige Iwao, Kawasaki-shi (JP); Yuji Wada, Kawasaki-shi (JP); Makoto Okada, Kawasaki-shi (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/961,293

(22) Filed: Sep. 25, 2001

(30) Foreign Application Priority Data
Apr. 26, 2001 (JP) 2001-129485

(51) Int. Cl. H04L 9/00; H04L 9/32

(52) U.S. Cl. 713/150; 713/193

(57) ABSTRACT

A content distribution system includes a data processing apparatus of a user for receiving a content supplied from a content transmitter, a data processing apparatus of a third party trusted by both the content transmitter and the user, and a communications network connecting the data processing apparatuses of the user and the third party for mutual data communication. The data processing apparatus of the user is provided with a tamper-resistant device storing data inaccessible from outside. The data processing apparatus of the third party transmits first data to the data processing apparatus of the user, wherein the first data relates to an encryption key that decodes a cipher generated by the content transmitter. The encryption key is obtained only within the tamper-resistant device. The tamper-resistant device decodes the cipher by using the first data from the data processing apparatus of the third party.

### BACKGROUND OF THE INVENTION

1. Field of the Invention

The present invention relates to a system of distributing digital productions, such as music, graphics and computer programs, through communications networks (such as the Internet) or by using portable storage mediums (such as optical disks). The present invention also relates to computer programs and hardware used for such a distribution system. The hardware includes an anti-tampering unit and a server.

2. Description of the Related Art

As is known, many kinds of information are transmitted between communications terminals (e.g. personal computer) through the existing communications networks including the Internet. Such information includes music, graphics or computer programs for example. The creators (or copyright holders) of these artificial items or software (called the “content” hereinafter) may wish to distribute his or her productions to as many people as possible. The content receivers may be required to pay a certain amount of money before they can enjoy the distributed contents.

One way for allowing only legitimate receivers (i.e., receivers having paid the required money) to enjoy the content is to use cryptography. Specifically, first the transmitter transforms the content into a cipher by virtue of a key, and then transmits the cipher to the legitimate receiver through the communications network. Together with the encrypted content, the receiver is also provided with a secret key for decrypting the cipher. To avoid abuse, the secret key should be safely handed out to the legitimate receiver.

Conventionally, use may be made of an “escrow” service for ensuring that the required payment is to be made and that the transaction of the decrypting key is to be carried out safely between the content transmitter and the content receiver. The escrow service needs an intermediary approved by both the transmitter and the receiver. Typically, the intermediary is a banking institution. The authorized intermediary settles accounts for the payment of the content. After confirming that the requested payment has been made, the intermediary provides the content receiver with the decrypting key.

The escrow service can be utilized in various situations. For instance, it may be employed when an individual or a small company wishes to distribute contents, or when contents are sold at an auction, or when contents are sold by a P2P (peer to peer) transaction which is currently coming into wide use. As is known, in a P2P transaction, contents are transmitted from one terminal to another without using a server.

Unfavorably, the conventional escrow service suffers the abusing of the decrypting key supplied to the content receiver. Specifically, the conventional system has no means of preventing a legitimate receiver of the secret key from lending the obtained key to a person unauthorized to use the key. Therefore, the unauthorized person can easily decode the encrypted content using the decrypting key, and access the hidden information without making the payment.

### SUMMARY OF THE INVENTION

The present invention has been proposed under the circumstances described above. It is, therefore, an object of the present invention to provide a content distribution system whereby a license key is reliably concealed. Another object of the present invention is to provide a tamper-resistant device, a server and a computer program used for such a system.

According to a first aspect of the present invention, there is provided a content distribution system which includes: a data processing apparatus of a user for receiving a content supplied from a content transmitter; a data processing apparatus of a third party trusted by both the content transmitter and the user; and a communications network connecting the data processing apparatuses of the user and the third party for mutual data communication. The data processing apparatus of the user is provided with a tamper-resistant device storing data inaccessible from outside. The data processing apparatus of the third party transmits first data to the data processing apparatus of the user, where the first data relates to an encryption key that decodes a cipher generated by the content transmitter. The encryption key is obtained only within the tamper-resistant device. The tamper-resistant device decodes the cipher by using the first data from the data processing apparatus of the third party.

According to a second aspect of the present invention, there is provided a content distribution system which includes: a data processing apparatus of a content transmitter that transmits a content; a data processing apparatus of a user that receives the content; a data processing apparatus of a third party trusted by both the content transmitter and the user; and a communications network connecting the data processing apparatuses of the content transmitter, the user and the third party for mutual data communication. The data processing apparatus of the content transmitter supplies a cipher to the data processing apparatus of the user. The data processing apparatus of the user is provided with a tamper-resistant device storing data inaccessible from outside. The data processing apparatus of the third party transmits first data to the data processing apparatus of the user, where the first data relates to an encryption key that decodes the cipher. The encryption key is obtained only within the tamper-resistant device. The tamper-resistant device decodes the cipher by using the first data from the data processing apparatus of the third party.

Preferably, the data processing apparatus of the third party stores a public key and a secret key. The public key is transmitted to the data processing apparatus of the content transmitter as required by the data processing apparatus of the content transmitter. The data processing apparatus of the content transmitter encodes the encryption key by using the public key from the data processing apparatus of the third party. The encoded encryption key is transmitted to the data processing apparatus of the user. The data processing apparatus of the user causes the tamper-resistant device to generate second data based on the encoded encryption key from the data processing apparatus of the content transmitter. The second data is transmitted to the data processing apparatus of the third party. The data processing apparatus of the third party generates the first data based on the secret key and the second data supplied from the data processing apparatus of the user.

Preferably, the system of the present invention further includes an additional third party, wherein the tamper-resistant device divides the second data into pieces one of which is received by a relevant one of the third parties.

Preferably, the tamper-resistant device allows mixing of a random number component in generating the second data based on the encoded encryption key, while also allowing removal of the random number component from the first data in decoding the cipher by using the first data.

Preferably, the tamper-resistant device stores information on the public key in a form of a digital certificate by an authentication agency. The tamper-resistant device is supplied to the user after the user is identified by the authentication agency. The data processing apparatus of the third party confirms the identification of the user based on the public key information supplied in the form of the digital certificate from the data processing apparatus of the user.

According to a third aspect of the present invention, there is provided a tamper-resistant device used in a content distribution system, where the system includes a data processing apparatus of a content transmitter to supply an encrypted content, a data processing apparatus of a user to receive the supplied content, a data processing apparatus of a third party which is trusted by both the content transmitter and the user and supplies data on a key to decode the encrypted content, and a communications network connecting the respective data processing apparatuses to each other for mutual data communication. The tamper-resistant device may include: a memory storing data inaccessible from outside; a key obtainer that restores the decoding key based on the key data supplied from the data processing apparatus of the third party; and a decoder that decodes the encrypted content by using the decoding key restored by the key obtainer.

According to a fourth aspect of the present invention, there is provided a server used in a content distribution system, where the system includes a data processing apparatus of a content transmitter to supply an encrypted content, a data processing apparatus of a user to receive the supplied content, a data processing apparatus of a third party trusted by both the content transmitter and the user, a communications network connecting the respective data processing apparatuses to each other for mutual data communication, and a tamper-resistant device provided on the data processing apparatus of the user for storing data inaccessible from outside. The server works as the data processing apparatus of the third party. The server may includes: a data generator that generates first data relating to a key to decode the encrypted content from the data processing apparatus of the content transmitter, the decoding key being generated only within the tamper-resistant device; a data transmitter that sends the first data to the data processing apparatus of the user via the communications network.

According to a fifth aspect of the present invention, there is provided a computer program used in a content distribution system, where the system includes a data processing apparatus of a content transmitter to supply an encrypted content, a data processing apparatus of a user to receive the supplied content, a data processing apparatus of a third party trusted by both the content transmitter and the user, a communications network connecting the data processing apparatuses of the content transmitter, the user and the third party for mutual data communication, and a tamper-resistant device provided on the data processing apparatus of the user. The tamper-resistant device stores data inaccessible from outside. The computer program is prepared for controlling the data processing apparatus of the third party, and includes: a data generation program for generating first data relating to a key that decodes the encrypted content from the data processing apparatus of the content transmitter, the decoding key being generated only within the tamper-resistant device; and a data transmission program for sending the first data to the data processing apparatus of the user via the communication network.

According to a sixth aspect of the present invention, there is provided a content distribution process performed in a system that comprises a data processing apparatus of a user to receive an encrypted content supplied from a content transmitter, a data processing apparatus of a third party trusted by both the content transmitter and the user, and a communications network connecting the data processing apparatuses of the user and the third party for mutual data communication. The content distribution process includes the steps of: causing the data processing apparatus of the user to issue an instruction to the data processing apparatus of the third party for carrying out a procedure to make a payment for the content; causing the data processing apparatus of the third party to send first data to the data processing apparatus of the user when the payment for the content is made from an account of the user to an account of the third party, the first data serving to provides a key that decodes the encrypted content, the decoding key being available only within the data processing apparatus of the user; and causing the data processing apparatus of the user to decode the encrypted content using the first data supplied from the data processing apparatus of the third party.

Preferably, the data processing apparatus of the user is provided with a tamper-resistant device that stores data inaccessible from outside. The decoding of the encrypted content is performed by the tamper-resistant device.

Preferably, the data processing apparatus of the third party stores a public key and a secret key. The data processing apparatus of the user generates second data based on the decoding key. The decoding key is supplied from the content transmitter and encrypted by the public key. The second data is transmitted to the data processing apparatus of the third party. The data processing apparatus of the third party generates the first data based on the second data and the secret key.

Preferably, the data processing apparatus of the user allows mixing of a random number component in generating the second data based on the encrypted decoding key, and the random number component is removed from the first data when the first data decodes the encrypted content.

Preferably, the tamper-resistant device generates the second data and decodes the encrypted content.

Preferably, the data processing apparatus of the third party carries out the payment procedure from the account of the third party to the account of the content transmitter when the data processing apparatus of the third party receives content confirmation notice from the data processing apparatus of the user.

Other features and advantages of the present invention will become apparent from the detailed description given below with reference to the accompanying drawings.

### BRIEF DESCRIPTION OF THE DRAWINGS

FIG. 1 is a diagram illustrating the basic concept of content distribution system embodying the present invention;

FIG. 2 shows the principal components of a terminal operated by a user of the content distribution system;

FIG. 3 illustrates a distribution protocol adopted for the content distribution system;

FIG. 4 shows an exemplary way of settling the charge for supply of a content; and

FIG. 5 illustrates the principles of divisional secret preservation.

### DETAILED DESCRIPTION OF THE PREFERRED EMBODIMENT

The preferred embodiments of the present invention will be described below with reference to the accompanying drawings.

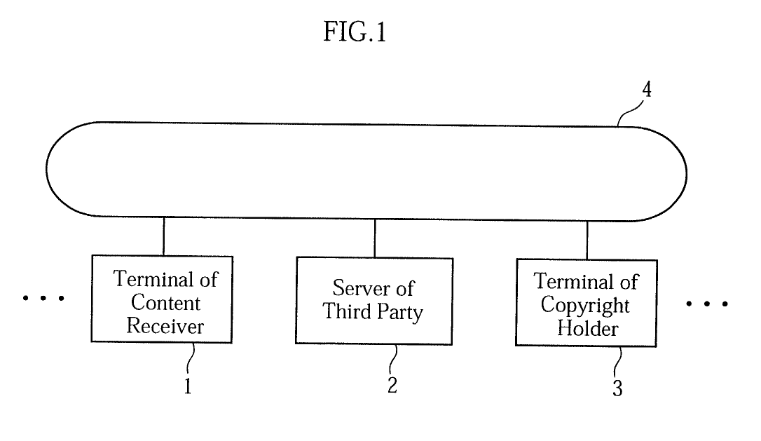

FIG. 1 illustrates the basic concept of a content distribution system embodying the present invention. As shown, this system includes terminals 1 of users (receivers of contents), a server 2 of a third party, terminals 3 of copyright holders (transmitters of contents), and a communications network 4. The terminals 1 and 3 are typically personal computers. The network 4 connects the terminals 1, the server 2, and the terminals 3 to each other. The network 4 may include the Internet, the servers of Internet connection agencies, the pubic telecommunication networks, and LANs (local area networks).

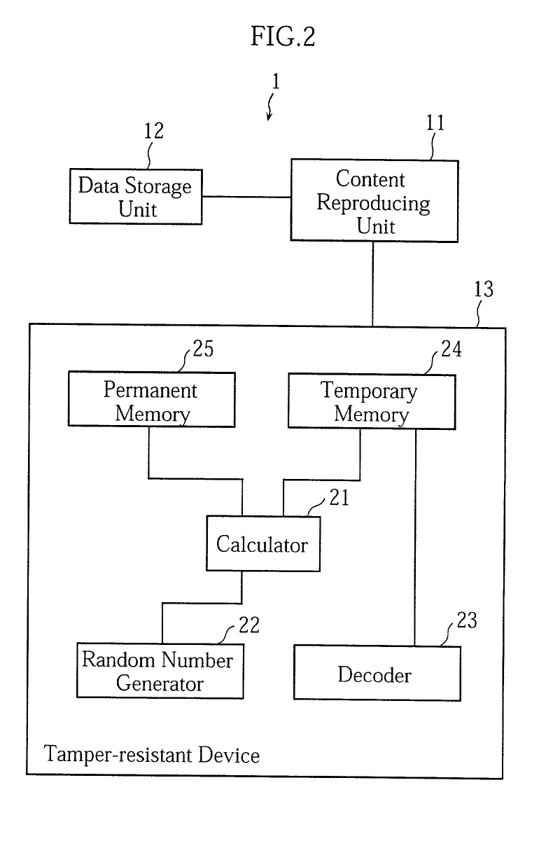

FIG. 2 shows the basic structure for the terminal 1 of a content receiver. As illustrated, the terminal 1 includes a content reproducing unit 11 and a data-storage unit 12. In association with the terminal 1, use is made of a tamper-resistant device 13 which is detachably connected to the terminal 1. As shown, the device 13 includes a calculator 21, a random number generator 22, a decoder 23, a temporary memory 24, and a permanent memory 25.

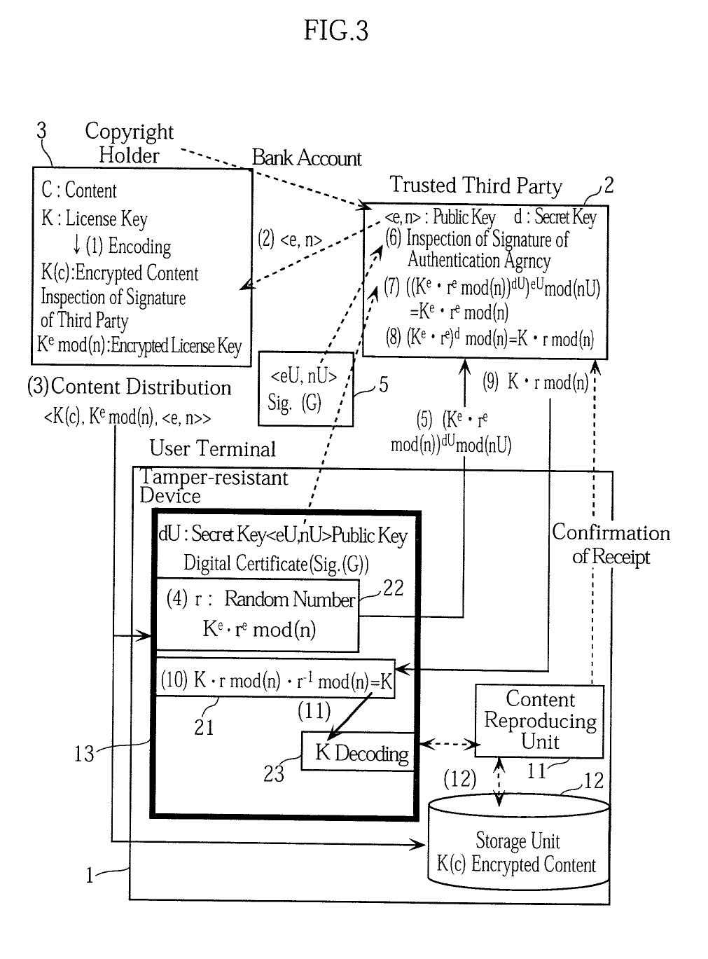

FIG. 3 illustrates a distribution protocol employed for the content distribution system of the present invention. In the figure, numeral 5 refers to an authentication agency which supplies a tamper-resistant device 13 to a legitimate content receiver. To this end, the authentication agency 5 confirms the identification of the receiver. The agency 5 is a trustable organization. Data stored in the device 13 is kept inaccessible to unauthorized people and also to the content receiver himself. The device 13 may be in the form of an IC card.

As noted above, the terminal 1 is typically a personal computer, though the present invention is not limited to this. For example, the terminal 1 may be a mobile telecommunication device (e.g. portable telephone), a computerized home video game having a data communication function, or a television set having a data processing function.

Referring back to FIG. 2, the content reproducing unit 11 reproduces the content supplied from the terminal 3 of a copyright holder. Initially, the supplied content is decrypted and stored in the data-storage unit 12. Then, the decrypted content is decoded for reproduction by a code system provided in the tamper-resistant device 13. The content reproducing unit 11 is realized by the CPU(central processing unit) incorporated in the terminal 1 of the receiver.

Typically, the data-storage unit 12 is realized by a hard disk device. Of course, the unit 12 may be provided with other rewritable nonvolatile memory (such as an optical disk) or volatile memory back-upped by a battery.

The calculator 21 calculates the residue of a large integer (1024-bit for example) raised to n-th power. Further, the calculator 21 calculates a key necessary for decoding the encrypted content supplied from the terminal 3 of a copyright holder. This calculation is performed based on the data supplied from the server 2, and the decoding is performed by the same algorithm as employed for encrypting the original plain content. The calculated key is stored in the temporary memory 24.

The random number generator 22 generates random numbers, as required.

The decoder 23 decrypts the encoded content stored in the data-storage unit 12. The decryption is performed with the use of the decrypting key calculated by the calculator 21.

The temporary memory 24 stores the random numbers generated by the random number generator 22. The memory 24 may be realized by a register or RAM(random access memory).

The permanent memory 25 stores a secret key and a corresponding public key prepared in accordance with public-key cryptography (asymmetric encryption). These keys are allotted exclusively for each tamper-resistant device 13 and stored in the form of a digital certificate signed by the authentication agency 5.

The server 2 is managed by a third party trustable to both the copyright holder of the content and the intended content receiver. Hereinafter, the third party may also be called “escrow organization.” The server 2 has the following functions. First, the server 2 holds a pair of keys (secret key and public key) prepared in accordance with public-key cryptography employing e.g. the RSA(Rivest-Shamir-Adleman) cryptoalgorithm. These keys are specific to the third party. The public key is safely supplied to the copyright holder by a digital certification scheme for example. Second, the server 2 verifies the genuineness of the public key stored in the permanent memory 25 of the tamper-resistant device 13 supplied to the content receiver from the authentication agency 5. This verification is performed by inspecting the electronic signature in the digital certificate from the agency 5. Third, the server 2 calculates the residue of the n-th power of a large integer (1024-bit for example). Fourth, the server 2 issues a public key certificate which carries informational pieces concerning e.g. how to access the server 2. Preferably, the third party as an escrow organization may be a financial organization (a bank for example) or an agency aligned with a financial organization.

The terminal 3 of a content transmitter (copyright holder) has a content-encrypting function, based on a single-key cryptosystem, to transform a content into a cipher by an encrypting key. This encrypting key is generated at the terminal 3 by the content transmitter and is kept secret. The cipher is transmitted to the terminal 1 of the content receiver via the network 4.

In the illustrated embodiment, the content transmitter has an account at the escrow organization to settle the payment for the supplied content. The terminal 3 of the content transmitter may be a mobile telecommunications device (such as a portable telephone), or computerized home video device having a data communications function, or television set having a data processing function.

The authentication agency 5 is a reliable organization which verifies that the owner of a tamper-resistant device 13 is authorized to use the device. The permanent memory 25 of the tamper-resistant device 13 stores a secret key and the corresponding public key. For this public key, the organization 5 attaches a digital signature in the form of a public key certificate.

The overall procedure in the content distribution system of the present invention will now be described below.

First, a copyright holder operates the terminal 3 to transform the content C of his creation into a cipher K(c) by using the encrypting key (license key) K generated at the terminal 3. Further, using the terminal 3, the copyright holder obtains a public key <e,n> from the server 2 of the escrow organization in the form of a public key certification. Then, using the public key <e,n>, the copyright holder encodes the license key K as K^{e}mod(n) , where K and n are integers which are relatively prime. The notation “K^{e}mod(n)” signifies the residue of the quotient K^{e}/n, where “K^{e}” is the e-th power of K. Then, using the terminal 3, the copyright holder transmits a data set <K(c), K^{e}mod(n), <e,n>> to the terminal 1 of the content receiver.

After obtaining the above data set from the terminal 3, the content receiver reproduces the original content C in the following manner. First, the content receiver stores the transmitted cipher K(c) in the data-storage unit 12 of the terminal 1. Also, the content receiver inputs the encrypted license key K^{e}mod(n) and the public key <e,n> into the tamper-resistant device 13. Upon this data input, the random number generator 22 of the device 13 generates a random number r (this number and the integer n should be relatively prime). The random number r is stored in the temporary memory 24.

Then, the calculator 21 calculates (K^{e}r^{e})mod(n). Advantageously, the involvement of a random number r makes the license key K anonymous (concealed). Further, using a secret key dU stored in the permanent memory 25, the calculator 21 calculates ((K^{e}r^{e})mod(n))^{dU}mod(nU). The calculation result is utilized to verify, to the escrow organization, that the secret key dU is held in the tamper-resistant device 13. Then, the tamper-resistant device 13 transmits a data set <((K^{e}r^{e})mod(n))^{dU}mod(nU), (K^{e}mod(n)) (r^{e}mod(n))> to the server 2 of the escrow organization. This transmission is performed based on access information contained in the public key certificate attached to the cipher K(c).

Upon receiving the data set <((K^{e}r^{e})mod(n)) ^{dU}mod(nU), (K^{e}mod(n)) (r^{e}mod(n))> from the terminal 1, the server 2 examines whether the public key <eU,nU> of the content receiver is valid or not. For this, the server 2 inspects the digital signature of the authentication agency 5 attached to the public key certificate of the content receiver. When the public key <eU,nU> is found to be valid, the server 2 checks on the content receiver based on the data set <((K^{e}r^{e})mod(n)) ^{dU}mod(nU), (K^{e}mod(n))(r^{e}mod(n))> supplied from the terminal 1. Specifically, the server 2 calculates ((K^{e}r^{e})mod(n)) ^{dU}mod(nU)=(K^{e}r^{e})mod(n) by using (K^{e}r^{e})mod(n)) ^{dU}mod(nU), and then compares the calculation result with (K^{e}mod(n))(r^{e}mod(n)). When these two values coincide, the server 2 verifies that the transmitter is a legitimate user. This verification is based on the fact that the above encryption can be performed only by the tamper-resistant device 13 incorporating the secret key dU corresponding to the public key <eU,nU>. When the content transmitter has been found legitimate, the content receiver makes the required payment to the escrow organization. The escrow organization delays the registration of the payment into the account of the copyright holder until it receives the confirmation of receipt from the content receiver.

Using the secret key d of its own, the server 2 of the escrow organization decodes the information obtained from the terminal 1 of the content receiver. This decoding is performed in accordance with (K^{e}r^{e}) ^{d}mod(n)=(Kr)mod(n). (The public key <e,n> and the secret key d are determined to satisfy this equation.) Since the calculation result involves multiplication of the random number r, and in general, it is difficult to carry out the factorization in prime numbers for a large integer, it is virtually impossible to find the license key K from the above calculation result. The server 2 of the escrow organization sends (Kr)mod(n) to the terminal 1 of the content receiver.

Upon receiving the (Kr)mod(n) from the server 2, the terminal 1 of the content receiver supplies it to the tamper-resistant device 13. Then, the calculator 21 of the device 13 calculates the reciprocal of rmod(n) by using the random number r stored in the memory 24. The obtained reciprocal “r⁻¹mod(n)” is multiplied by (Kr)mod(n). This calculation results in the revealing of the secret key K. The obtained key K is temporarily stored in the memory 24. As is known in the art, the reciprocal of an integer which is relatively prime to the integer “n” can be calculated by a simple but effective method called the Euclidean algorithm.

The content reproducing unit 11 reproduces the content C. Specifically, the content reproducing unit 11 reads out the encoded content or cipher K(c) from the data-storage unit 12, and supplies it to the tamper-resistant device 13. Then, the decoder 23 of the device 13 decrypts the cipher K(c) with the use of the license key K stored in the temporary memory 24. Then, the decoded content (“plain content”) C is supplied to the content reproducing unit 11. Thus, the unit 11 reproduces the plain content C, and the result will be outputted by e.g. the display of the terminal 1 of the content receiver.

According to the above system, the license key K is kept secret within the tamper-resistant device 13. Thus, it is possible to prevent the content receiver to transmit the key K to other unauthorized persons.

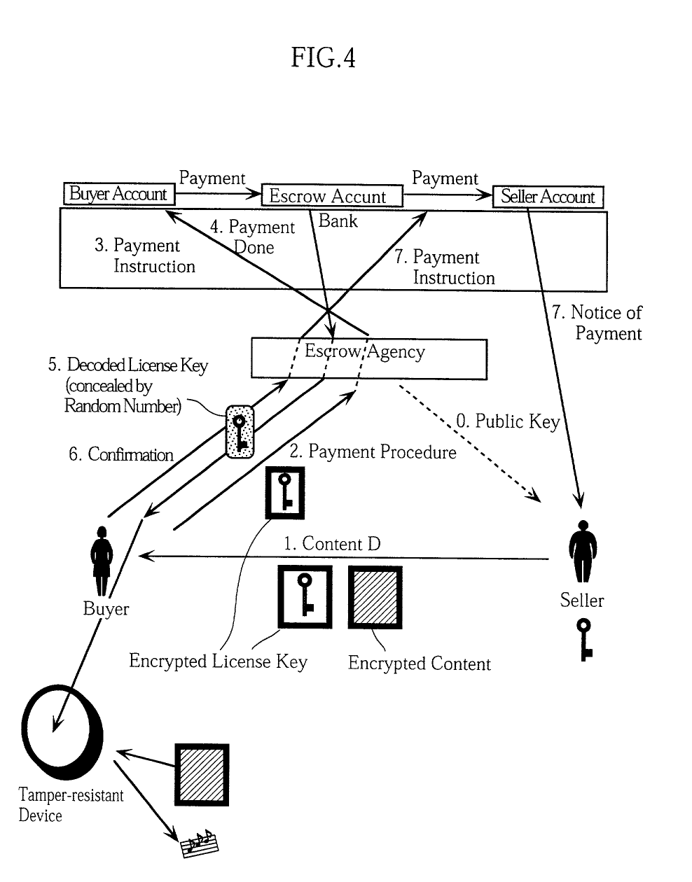

Reference is now made to FIG. 4 illustrating an exemplary way of settling the charge for using the content distribution system of the present invention.

First, a third party serving as escrow organization supplies a public key to the content transmitter (or seller). Precisely, the server 2 of the third party transmits a public key <e,n> to the terminal 3 of the content transmitter (copyright holder).

Then, the seller supplies the requested content C to the buyer (content receiver). Precisely, the terminal 3 of the copyright holder supplies the encrypted content K(c) and the encrypted license key (encryption key) K^{e}mod(n) to the terminal 1 of the buyer.

After obtaining the cipher K(c) and the license key, the buyer takes the necessary procedure for paying to the escrow organization. Precisely, the terminal 1 of the buyer transmits <((K^{e}r^{e})mod(n)) ^{dU}mod(nU), (K^{e}mod(n)) (r^{e}mod(n))> to the server 2 of the third party.

Upon this, the third party issues an instruction to pay into the bank account of the third party from the bank account of the buyer. When the third party is notified by a contracted bank that the necessary payment has been made, the third party supplies the license key to the buyer. Precisely, the server 2 of the third party transmits (Kr)mod(n) to the terminal 1 of the buyer. Thereafter, the buyer can reproduce the content C using the tamper-resistant device 13.

When the reproduction of the content C has been successful, the buyer gives the third party notice to that effect.

After receiving the confirmation of the payment from the buyer, the third party issues an instruction to transfer the deposited money from the bank account of its own to the bank account of the seller (content transmitter). When this money transfer has been properly done, the contracted bank gives the seller notice to that effect.

As noted above, the digital signature anonymity technique by the “blind signature” algorithm can advantageously be applied to making the license key anonymous. In this manner, the decoding of the encrypted content C is successfully performed, while the encrypting license key K is kept secret to the third party and the users of the system.

According to the above-described embodiment, the escrow organization (third party) does not keep the license key K for the content C. Instead, the third party discloses the public key <e,n> of its own, and provides a calculation service using the secret key d corresponding to the public key. When the content receiver is found to be a legitimate user of the system (the legitimacy is confirmed by the notice of complete payment issued from the bank), the third party calculates data (Kr)mod(n) with the use of the secret key d and supplies it to the content receiver. The obtained data (Kr)mod(n) works as a license key K only within the tamper-resistant device 13 of the content receiver. Therefore, even the authorized content receiver (buyer) cannot see or make a copy of the data (Kr)mod(n). In this manner, it is possible to overcome the conventional problem of abusing the license key K for the content C by an unauthorized person.

Further, in the tamper-resistant device 13, random number disturbance is performed for making the license key anonymous, as in the blind signature schema. With the key kept anonymous, the third party performs the decoding calculation. Then, back in the tamper-resistant device 13 again, the random number components are removed for data decryption. In this manner, it is possible to hide the key K from the third party.

Further, the third party does not need to take charge of the key K. Therefore, the security cost to care for the key K can be zero. Advantageously for the copyright holders, the content distribution cost is reduced since they do not need to pay the key deposit cost to the third party.

Further, the public key <eU,nU>, which is paired with the secret key dU stored in the permanent memory 25 of the tamper-resistant device 13, is safely supplied by the trustable authentication agency 5. Specifically, the agency 5 supplies the public key to the content receiver in the form of e.g. a public key certificate after the agency 5 has checked the identification of the content receiver. In this manner, the third party can check the identification of the owner of the tamper-resistant device 13.

Further, according to the above-described embodiment, there is no need to use special storage units or reproduction units. This is advantageous to reducing the running cost of the system. Thanks to the reduced cost, even an individual copyright holder or small-scale company with little capital may be able to readily start a content distribution business.

Further, in a P2P transaction, the utilization of the tamper-resistant device 13 prevents the illegitimate duplication of the supplied content C and license key K. Also, the utilization of the third party ensures safe settlement of payment.

In the above embodiment, the content distribution from the receiver terminal 1 to the transmitter terminal 3 is performed through the communications network 4. The present invention, however, is not limited to this. For instance, a portable storage device (an optical disk for example) storing the content C may be shared out from the content transmitter to the content receiver.

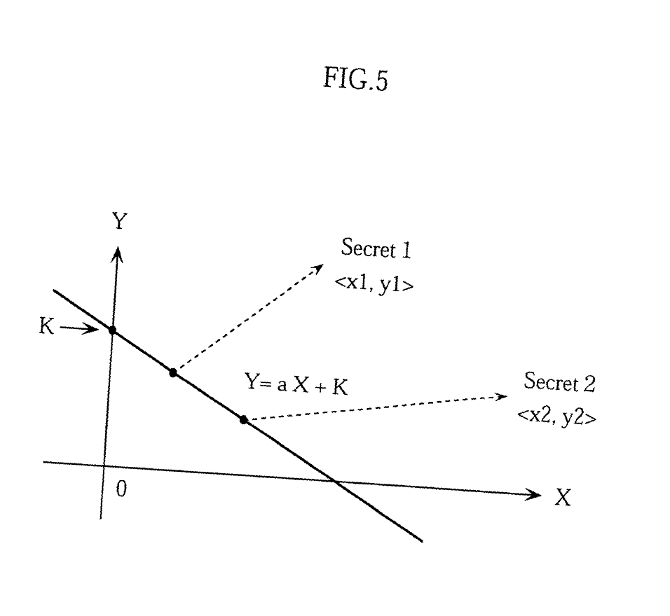

According to the present invention, more than one third party (escrow organization) may be involved in the system, so that the decrypting key will be kept secret even if the secret key of one (maybe more) third party is leaked out. To this end, specifically, each of the third parties may hold an allotted piece of data regarding one decrypting key. Then, as required, the third parties transmit their allotted pieces of data to the content receiver, thereby enabling the content receiver to access the hidden information of the content C. FIG. 5 illustrates the principle of such a secret dispersion system. In the illustrated example, the license key K is divided into two portions: Secret 1<x1,y1> and Secret 2<x2,y2>. The license key K can be reconstructed with both Secret 1 and Secret 2, but cannot with only one of them. The specific procedure may be as follows.

It is supposed that the tamper-resistant device 13 stores a secret key by the public-key cryptography, while the corresponding public key is revealed. Now the public key is represented by <nc, ec>, while the secret key by dc. The license key K is divided into two pieces of information by using a secret dispersion algorithm. For carrying out this division, the following formulas may be used: Y1=K+(A·X1)mod(P); Y2=K+(A·X2)mod(P), where X1, X2 and A are random numbers, while P is a prime number. According to these formulas, the license key K is divided into <X1,Y1> and <X2,Y2>. Then, Y1 is encrypted into (Y1)^{ec}mod(nc) by the public key <nc,ec> of the tamper-resistant device 13, while Y2 is encrypted into (Y2)^{e}mod(n). Then, the encrypted content, (Y1) ^{ec}mod(nc), (Y2)^{e}mod(n), X1, X2 and P are transmitted to the content receiver. Then, (Y2)^{e}mod(n) is made anonymous by a random number within the tamper-resistant device 13, and transmitted to the server 2 of the third party. The server 2 sends back the decrypted results to the content receiver. The random number components are removed by the tamper-resistant device 13, and thus Y2 is obtained. Meanwhile, (Y1)^{ec}mod(nc) is decoded by the tamper-resistant device 13 with the use of the secret key dc, and thus Y1 is obtained. Thereafter, the tamper-resistant device 13 calculates Y1−((Y1−Y2)/(X1−X2))mod(P), from which the license key K results.

The above manner is advantageous to prohibiting the content receiver from obtaining the random number-free license key K without using the tamper-resistant device 13. (In an illegitimate case opposite to this, the content receiver may directly transmit K^{e}mod(n) to the server 2 of the third party for decoding, and may succeed in obtaining the random number-free license key K.) In addition, it is possible to prevent the third party from decrypting the key K. (Otherwise, the third party could decrypt the key K by referring to K^{e}mod(n) distributed with the content C.) This precaution may seem to be superfluous when the third party is a truly trustable organization. However, it may be better to make assurance doubly sure by dividing the key K in the above manner since the selection of a trustable third party cannot essentially overcome the unauthorized key decoding problem.

In the above-described embodiment, the supply of the public key <e,n> from the third party to the copyright holder is performed through the communications network 4. The present invention, however, is not limited to this, and the key supply may be carried out by other ways. Also, in the above embodiment, the RSA cryptoalgorithm is used. Obviously, this maybe replaced by other cryptosystems.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. A content distribution system comprising:
a data processing apparatus of a user for receiving a content supplied from a content transmitter;
a data processing apparatus of a third party trusted by both the content transmitter and the user; and
a communications network connecting the data processing apparatuses of the user and the third party for mutual data communication;
wherein the data processing apparatus of the user is provided with a tamper-resistant device storing data inaccessible from outside;
wherein the data processing apparatus of the third party transmits first data to the data processing apparatus of the user, the first data relating to an encryption key that decodes a cipher generated by the content transmitter, the encryption key being obtained only within the tamper-resistant device; and
wherein the tamper-resistant device decodes the cipher by using the first data from the data processing apparatus of the third party.

2. A content distribution system comprising:
a data processing apparatus of a content transmitter that transmits a content;
a data processing apparatus of a user that receives the content;
a data processing apparatus of a third party trusted by both the content transmitter and the user; and
a communications network connecting the data processing apparatuses of the content transmitter, the user and the third party for mutual data communication;
wherein the data processing apparatus of the content transmitter supplies a cipher to the data processing apparatus of the user;
wherein the data processing apparatus of the user is provided with a tamper-resistant device storing data inaccessible from outside;
wherein the data processing apparatus of the third party transmits first data to the data processing apparatus of the user, the first data relating to an encryption key that decodes the cipher, the encryption key being obtained only within the tamper-resistant device; and
wherein the tamper-resistant device decodes the cipher by using the first data from the data processing apparatus of the third party.

3. The system according to claim 2, wherein the data processing apparatus of the third party stores a public key and a secret key, the public key being transmitted to the data processing apparatus of the content transmitter as required by the data processing apparatus of the content transmitter;
wherein the data processing apparatus of the content transmitter encodes the encryption key by using the public key from the data processing apparatus of the third party, the encoded encryption key being transmitted to the data processing apparatus of the user;
wherein the data processing apparatus of the user causes the tamper-resistant device to generate second data based on the encoded encryption key from the data processing apparatus of the content transmitter, the second data being transmitted to the data processing apparatus of the third party; and
wherein the data processing apparatus of the third party generates the first data based on the secret key and the second data supplied from the data processing apparatus of the user.

4. The system according to claim 3, further comprising an additional third party, wherein the tamper-resistant device divides the second data into pieces one of which is received by a relevant one of the third parties.

5. The system according to claim 3, wherein the tamper-resistant device allows mixing of a random number component in generating the second data based on the encoded encryption key, while also allowing removal of the random number component from the first data in decoding the cipher by using the first data.

6. The system according to claim 2, wherein the tamper-resistant device stores information on the public key in a form of a digital certificate by an authentication agency, the tamper-resistant device being supplied to the user after the user is identified by the authentication agency; and
wherein the data processing apparatus of the third party confirms the identification of the user based on the public key information supplied in the form of the digital certificate from the data processing apparatus of the user.

7. A tamper-resistant device used in a content distribution system, the system comprising a data processing apparatus of a content transmitter to supply an encrypted content, a data processing apparatus of a user to receive the supplied content, a data processing apparatus of a third party which is trusted by both the content transmitter and the user and supplies data on a key to decode the encrypted content, and a communications network connecting the respective data processing apparatuses to each other for mutual data communication, the tamper-resistant device comprising:
a memory storing data inaccessible from outside;
a key obtainer that restores the decoding key based on the key data supplied from the data processing apparatus of the third party; and
a decoder that decodes the encrypted content by using the decoding key restored by the key obtainer.

8. A server used in a content distribution system, the system comprising a data processing apparatus of a content transmitter to supply an encrypted content, a data processing apparatus of a user to receive the supplied content, a data processing apparatus of a third party trusted by both the content transmitter and the user, a communications network connecting the respective data processing apparatuses to each other for mutual data communication, and a tamper-resistant device provided on the data processing apparatus of the user for storing data inaccessible from outside, the server working as the data processing apparatus of the third party, the server comprising:
a data generator that generates first data relating to a key to decode the encrypted content from the data processing apparatus of the content transmitter, the decoding key being generated only within the tamper-resistant device; and
a data transmitter that sends the first data to the data processing apparatus of the user via the communications network.

9. A computer program used in a content distribution system, the system comprising a data processing apparatus of a content transmitter to supply an encrypted content, a data processing apparatus of a user to receive the supplied content, a data processing apparatus of a third party trusted by both the content transmitter and the user, a communications network connecting the data processing apparatuses of the content transmitter, the user and the third party for mutual data communication, and a tamper-resistant device provided on the data processing apparatus of the user, the tamper-resistant device storing data inaccessible from outside, the computer program being prepared for controlling the data processing apparatus of the third party, the computer program comprising:
a data generation program for generating first data relating to a key that decodes the encrypted content from the data processing apparatus of the content transmitter, the decoding key being generated only within the tamper-resistant device; and
a data transmission program for sending the first data to the data processing apparatus of the user via the communication network.

10. A content distribution process performed in a system that comprises a data processing apparatus of a user to receive an encrypted content supplied from a content transmitter, a data processing apparatus of a third party trusted by both the content transmitter and the user, and a communications network connecting the data processing apparatuses of the user and the third party for mutual data communication, the content distribution process comprising the steps of:
causing the data processing apparatus of the user to issue an instruction to the data processing apparatus of the third party for carrying out a procedure to make a payment for the content;
causing the data processing apparatus of the third party to send first data to the data processing apparatus of the user when the payment for the content is made from an account of the user to an account of the third party, the first data serving to provides a key that decodes the encrypted content, the decoding key being available only within the data processing apparatus of the user; and
causing the data processing apparatus of the user to decode the encrypted content using the first data supplied from the data processing apparatus of the third party.

11. The process according to claim 10, wherein the data processing apparatus of the user is provided with a tamper-resistant device that stores data inaccessible from outside, the decoding of the encrypted content being performed by the tamper-resistant device.

12. The process according to claim 10, wherein the data processing apparatus of the third party stores a public key and a secret key,
wherein the data processing apparatus of the user generates second data based on the decoding key, the decoding key being supplied from the content transmitter and encrypted by the public key, the second data being transmitted to the data processing apparatus of the third party, and
wherein the data processing apparatus of the third party generates the first data based on the second data and the secret key.

13. The process according to claim 12, wherein the data processing apparatus of the user allows mixing of a random number component in generating the second data based on the encrypted decoding key, the random number component being removed from the first data when the first data decodes the encrypted content.

14. The process according to claim 13, wherein the tamper-resistant device generates the second data and decodes the encrypted content.

15. The process according to claim 10, wherein the data processing apparatus of the third party carries out the payment procedure from the account of the third party to the account of the content transmitter when the data processing apparatus of the third party receives content confirmation notice from the data processing apparatus of the user.
